(19) United States
(12) Patent Application Publication
(10) Pub. No.: US 2012/0036550 A1
(43) Pub. Date: Feb. 9, 2012

(54) System and Method to Measure and Track Trust

(75) Inventors: Ricardo J. Rodriguez, Palmetto, FL (US); Ray Andrew Green, Marana, AZ (US)

(73) Assignee: Raytheon Company, Waltham, MA (US)

(21) Appl. No.: 12/849,409

(22) Filed: Aug. 3, 2010

(51) Int. Cl. G06F 17/00

(52) U.S. Cl. 726/1

(57) ABSTRACT

In some embodiments, a method of determining an overall level of trust of a system comprises receiving a level of trust for each of a plurality of elements of the system. A weight for each of the plurality of elements is received, each weight indicating an influence of each of the plurality of elements on the trust of the system. A contribution for each element to the overall level of trust of the system is determined based on the level of trust for each element and the weight for each element. The overall level of trust of the system is determined based on the determined contribution for each element.

### TECHNICAL FIELD

The present disclosure relates to system trust generally and more specifically to systems and methods to measure and track trust.

### BACKGROUND

From a human perspective, trust may represent the psychological state comprising expectancy, belief, and willingness to be vulnerable. Thus, for example, trust may provide context to human interactions, as humans uses concepts of trust every day to determine how to interact with known, partially-known, and unknown people. There may be numerous aspects or variables used to represent the value of trust. Example aspects of trust may include (1) reliability, (2) the ability to perform actions within a reasonable timeframe, (3) honesty, and (4) confidentiality.

The concept of trust may also apply to non-human interactions. For example, in an information-based transaction between two systems, a provider system may transmit data to a consumer system. In this example, the provider and consumer may act as both trustor and trustee. For example, the consumer may have some level of trust that the received data is accurate, and the provider may have some level of trust that the consumer will use the data for an authorized purpose. In this manner, the trust of the provider may represent the accuracy of the data provided, and the trust of the consumer may represent the consumer's ability to restrict use of the data to authorized purposes.

It is well known in the art that trust may be modeled and quantified. For example, concepts such as trustor and trustee may be used in combination with degrees or levels of trust and distrust to quantify trust. Examples of attempts to develop models that will accurately represent trust include the following: Huang, J., & Nicol, D, A calculus of Trust and Its Application to PKI and Identity Management (2009); MAHMOUD, Q., COGNITIVE NETWORKS: TOWARDS SELF-AWARE NETWORKS (2007); D Arienzo, M., & Ventre, G., Flexible node design and implementation for self aware networks 150-54 (International Workshop on Database and Expert System Applications) (2005); Chang, J., & Wang, H., A dynamic trust metric for P2P systems (International Conference on Grid and Cooperative Computing Workshops) (2006). Many of these examples are limited to context specific solutions to particular problems (e.g., trust in peer-to-peer communication).

As stated above, trust may represent the psychological state comprising expectancy, belief, and willingness to be vulnerable. Expectancy may represent a performer's perception that it is capable of performing as requested. Belief may represent another's perception that the performer will perform as requested. Willingness to be vulnerable may represent one's ability to accept the risks of non-performance. With these concepts in mind, the foundation of a trust calculus may be based on two characteristics of trust. First, trust in what the trustee performs may be represented by:

trust_{—}p(d,e,x,k)≡madeBy(x,e,k)⊃believe(d,k\dot{⊃}x),

where d represents the trustor, e is the trustee, x is the expectancy, and k is the context. The context may be indicative of what performance is requested and the circumstances regarding performance. Second, trust in what the trustee believes may be represented by:

trust_{—}b(d,e,x,k)≡believe(e,k\dot{⊃}x)⊃believe(d,k\dot{⊃}x).

Similarly, the degrees of trust may be represented as follows:

td^{p}(d,e,x,k)=pr(believe(d,x)|madeBy(x,e,k) [symbol] beTrue(k)), and

td^{b}(d,e,x,k)=pr(believe(d,x)|believe(e,x) [symbol] beTrue(k)).

Trust may also change over time. As one example, trust between a service and a consumer may increase over time as their relationship develops. As another example, external forces may change the trust of one party to an interaction. For example, in a computer network, one computer may contract a virus, and this virus could inhibit the computer's ability to keep information confidential or to process information in a reasonable timeframe.

Trust may also be transitive. For example, if system A trusts system B, and B trusts system C, then in some environments A automatically trusts C. Returning to the computer network example, the trust developed between two computers may propagate to other computers based on the trust relationships between those computers and the transitive nature of trust. In the same example, if a computer becomes vulnerable due to a virus, then the vulnerability may propagate throughout the network.

### SUMMARY

In some embodiments, a method of determining an overall level of trust of a system comprises receiving a level of trust for each of a plurality of elements of the system. A weight for each of the plurality of elements is received, each weight indicating an influence of each of the plurality of elements on the trust of the system. A contribution for each element to the overall level of trust of the system is determined based on the level of trust for each element and the weight for each element. The overall level of trust of the system is determined based on the determined contribution for each element.

Certain embodiments may provide one or more technical advantages. A technical advantage of one embodiment may include the capability to proactively identify security breaches, provide timely alerts to operators, and execute recovery procedures to increase the trust of the system to acceptable levels. A technical advantage of one embodiment may also include the capability to use a systems model to track and model trust based on the elements of a system and the trust relationships among those elements. A technical advantage of one embodiment may also include the capability to account for how each sub-element influences trust of other elements at different levels by using weight values. A technical advantage of one embodiment may also include the capability to provide visualization tools may enable an operator to identify vulnerabilities in a system and respond to correct those vulnerabilities.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIG. 1 shows a system trust model of a system according to one embodiment;

FIG. 2A shows a trust management system according to one embodiment;

FIG. 2B shows a computer system according to one embodiment;

FIG. 3 shows an example entity relationship diagram (ERD) according to one embodiment;

FIG. 4 shows an example trust visualization according to one embodiment;

FIG. 5 shows a method of determining system trust according to one embodiment; and

FIG. 6 shows two example systems and the inter-trust level between them.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below.

In the computer network example described above, the trust of each computer may be measured and tracked. Additionally, the trust of the computer network itself may also be tracked. In this example, the trust of the computer network may be a function of the trust of each system within the network. Thus, this example may also illustrate a systems model of trust. Teachings of certain embodiments recognize the capability to use a systems model to track and model trust based on the elements of a system and the trust relationships among those elements. Additionally, teachings of certain embodiments recognize the capability to model the relationships between elements of a system and to measure and track propagation of trust throughout a system.

Under a systems model, a system may comprise one or more elements. Each of these elements may also comprise their own elements, or sub-elements. Teachings of certain embodiments recognize the ability to model trust of a system and each of the elements within the system. For example, teachings of certain embodiments recognize the ability to determine an overall trust of a system by determining the trust of each element within the system.

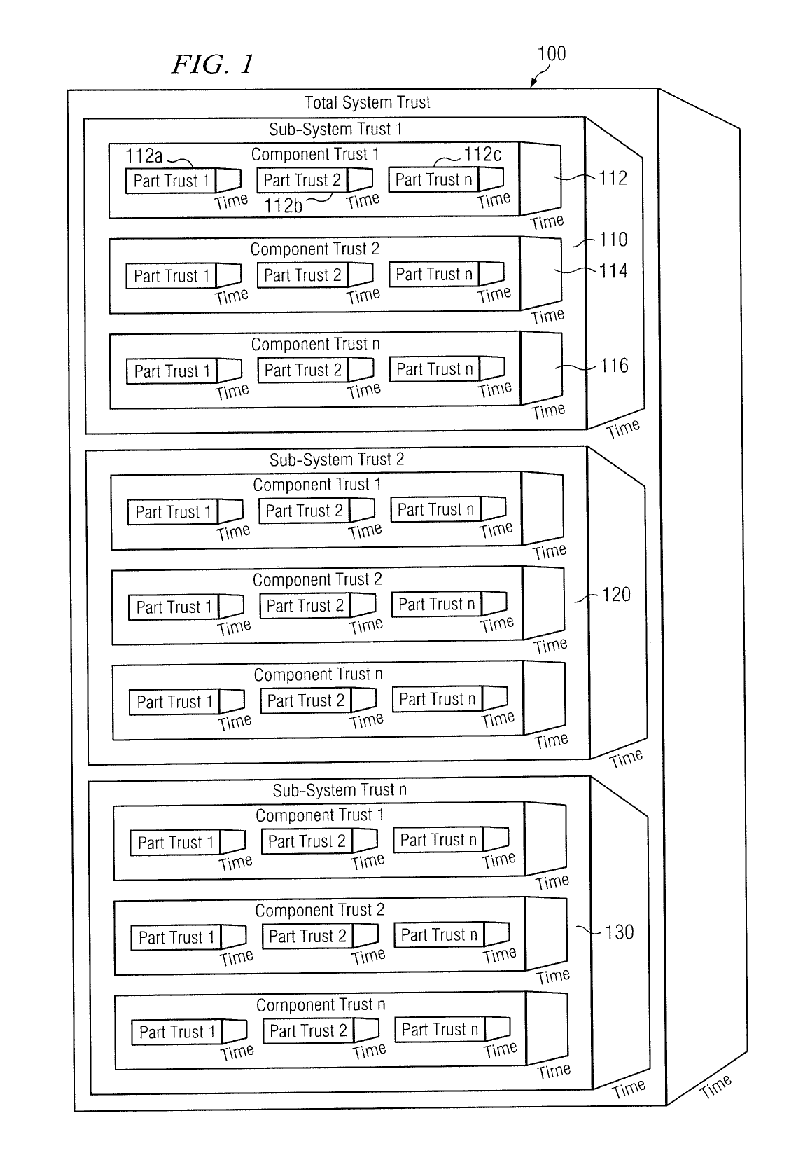

FIG. 1 shows a system trust model of an example system 100 according to one embodiment. In this example, system 100 includes several layers of elements. These exemplary layers of elements include sub-systems, components, and parts.

In the illustrated embodiment, system 100A comprises sub-systems 110, 120, and 130. Each sub-system may comprise one or more components. For example, sub-system 110 comprises components 112, 114, and 116. Each component may comprise one or more parts. For example, component 112 comprises parts 112a, 112b, and 112c. Although this example is described as a system with sub-systems, components, and parts, teachings of certain embodiments recognize that a system may include any number of element layers and any number of elements within each layer. Teachings of certain embodiments also recognize elements may belong to multiple systems and/or multiple layers. As one example, in some embodiments part 112a may also be a part in sub-system 120 and a component in sub-system 130.

In another example, a system i may include sub-systems, components, subcomponents, and parts. The following example provides an nth-dimensional representation of system i. In this nth-dimensional representation, a sub-system may be represented as j, a component may be represented as k, a subcomponent may be represented as l, and a part may be represented as m. In this example, the following terms define the relationships between the different elements of system i:
Tᵢ=Trust of System i
Tᵢⱼ=Trust of subsystem l belonging to system i
Tᵢⱼₖ=Trust of component k belonging to subsystem j, which belongs to system i
Tᵢⱼₖₗ=Trust of subcomponent l belonging to component k, which belongs to subsystem j, which belongs to system i
Tᵢⱼₖₗₘ=Trust of part m belonging to subcomponent l, which belongs to component k, which belongs to subsystem j, which belongs to system i
   Starting at the lowest level, the trust level of system i=1, subsystem j=1, component k=1, subcomponent l=1 can be determined as follows:

$${T}_{1111} = {T}_{11111} + {T}_{11112} + … + {T}_{1111 n}$$

$${T}_{1111} = {\sum }_{m = 1}^{n} {T}_{1111 m} where 0 < n < ∞$$

In general terms, for any system, subsystem, component, and subcomponent combination, the trust can be calculated as follows:

$${T}_{ijkl} = {\sum }_{m = 1}^{n} {T}_{ijklm} where 0 < n < ∞ \qquad ( a )$$

Similarly, the trust level of any {system, subsystem, component} can be calculated as follows:

$${T}_{ijk} = {\sum }_{l = 1}^{n} {T}_{ijkl} where 0 < n < ∞ \qquad ( b )$$

A {system, subsystem} is calculated as follows:

$${T}_{ij} = {\sum }_{k = 1}^{n} {T}_{ijk} where 0 < n < ∞ \qquad ( c )$$

And finally, the system trust is determined by:

$${T}_{i} = {\sum }_{j = 1}^{n} {T}_{ij} where 0 < n < ∞ \qquad ( d )$$

In other words, the total trust of system i may be determined as a function of each sub-system j of system i, the total trust of each sub-system j may be determined as a function of each component k within that sub-system j, and so on. Thus, teachings of certain embodiments recognize that the total trust of a system is a function of the trust of each element within the system.

However, each element of a system influence trust of other elements and the overall system at different levels. Some elements have a higher influence on trust than others. Accordingly, teachings of certain embodiments also recognize the ability to account for how each sub-element influences trust of other elements at different levels by using weight, W, values:

0≦W≦1

Accordingly, equations (a)-(d) can be rewritten as follows:

$${T}_{ijkl} = {\sum }_{m = 1}^{n} ( {T}_{ijklm} \cdot {W}_{ijklm} ) where 0 < n < ∞ and {\sum }_{m = 1}^{n} {W}_{ijklm} = 1 \qquad ( e )$$

### Similarly,

$$\begin{matrix}{T}_{ijk} = {\sum }_{l = 1}^{n} ( {T}_{ijkl} \cdot {W}_{ijkl} ) where 0 < n < ∞ and {\sum }_{l = 1}^{n} {W}_{ijkl} = 1 & ( f ) \\ {T}_{ij} = {\sum }_{k = 1}^{n} ( {T}_{ijk} \cdot {W}_{ijk} ) where 0 < n < ∞ and {\sum }_{k = 1}^{n} {W}_{ijk} = 1 & ( g ) \\ {T}_{i} = {\sum }_{j = 1}^{n} ( {T}_{ij} \cdot {W}_{ij} ) where 0 < n < ∞ and {\sum }_{j = 1}^{n} {W}_{ij} = 1 & ( h )\end{matrix}$$

Teachings of certain embodiments also recognize that the value of trust for each element may change over time. To account for the dynamic nature of both trust value and weight of sub-elements, equations (e)-(h) can be rewritten as follows:

$$\begin{matrix}{T}_{ijkl} = {\sum }_{m = 1}^{n} ( {T}_{ijklm} ( t ) \cdot {W}_{ijklm} ( t ) ) where 0 < n < ∞ and {\sum }_{m = 1}^{n} {W}_{ijklm} ( t ) = 1 & ( i ) \\ {T}_{ijk} = {\sum }_{l = 1}^{n} ( {T}_{ijkl} ( t ) \cdot {W}_{ijkl} ( t ) ) where 0 < n < ∞ and {\sum }_{m = 1}^{n} {W}_{ijkl} ( t ) = 1 & ( j ) \\ {T}_{ij} = {\sum }_{m = 1}^{n} ( {T}_{ijk} ( t ) \cdot {W}_{ijk} ( t ) ) where 0 < n < ∞ and {\sum }_{k = 1}^{n} {W}_{ijk} ( t ) = 1 & ( k ) \\ {T}_{i} = {\sum }_{j = 1}^{n} ( {T}_{ij} ( t ) \cdot {W}_{ij} ( t ) ) where 0 < n < ∞ and {\sum }_{j = 1}^{n} {W}_{ij} ( t ) = 1 & ( l )\end{matrix}$$

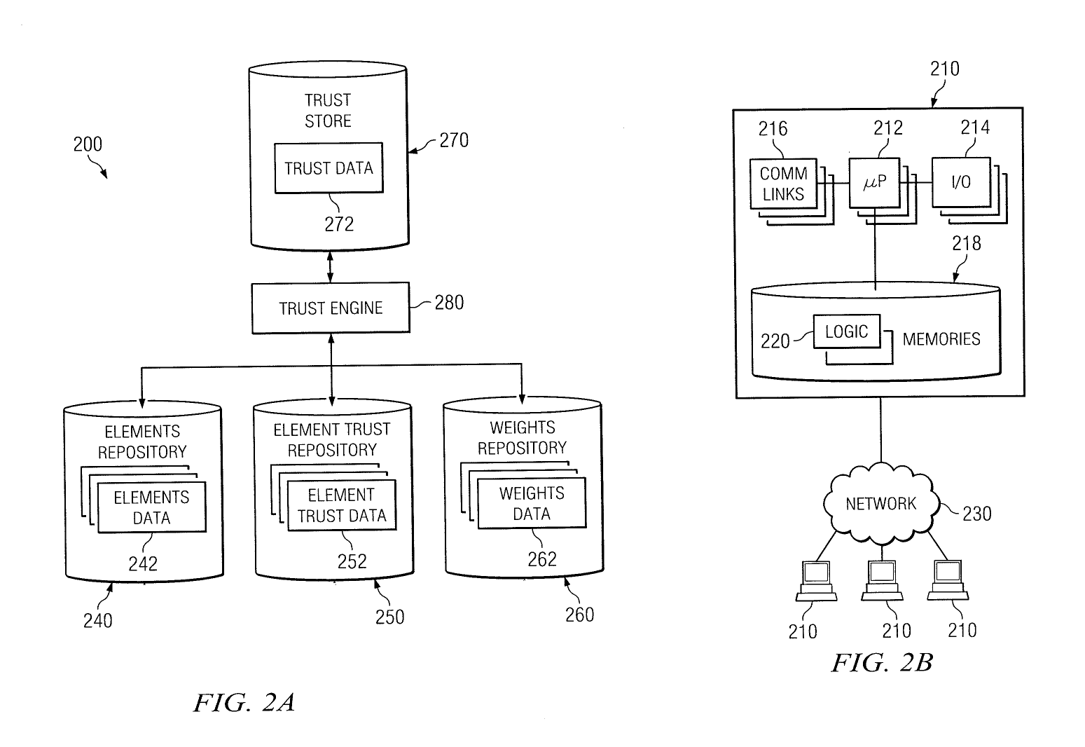

FIG. 2A shows a trust management system 200 according to one embodiment. FIG. 2B shows a computer system 210 according to one embodiment. Teachings of certain embodiments recognize that trust management system 200 may be implemented by and/or on one or more computer systems 210.

Trust management system 200 may measure and track trust of a system, such as system 100A, and the elements of that system. The trust management system 200 of FIG. 2 features an elements repository 240, an element trust repository 250, a weights repository 260, a trust store 270, and a trust engine 280.

Elements repository 240 stores elements data 242. Elements data 242 identifies the elements of a system or of multiple systems and the relationship between these elements. For example, system 100A of FIG. 1A features several levels of sub-systems, components, and parts. Elements data 242 may identify each of these elements and how they relate to each other. For example, elements data 242 may identify components 1, 2, and n as being a part of subs-system 1. Elements data 242 may also identify parts 1, 2, and n as being a part of component 1.

In the illustrated embodiment, element trust repository 250 stores element trust data 252. Element trust data 252 identifies an element trust value for each element. In the example system i, element trust data 252 may include values for the element sub-systems, components, sub-components, and parts, which may be represented mathematically as Tᵢ, Tᵢⱼ, Tᵢⱼₖ, Tᵢⱼₖₗ, and/or Tᵢⱼₖₗₘ. This elements trust data 252 may also change as a function of time. In one example, element trust data 252 includes trust values for the lowest-level elements, here Tᵢⱼₖₗₘ, and trust engine 280 calculates values for Tᵢ, Tᵢⱼ, Tᵢⱼₖ, and Tᵢⱼₖₗ and stores them as part of trust data 272.

In some embodiments, the element trust values for each element are normalized according to a baseline. Returning to the virus example, anti-virus software may report on the trust of an element by including both an element trust value and a baseline trust value and/or a normalized trust value. A baseline trust value may represent any benchmark for comparing trust values. A normalized trust value is an element trust value adjusted according to the baseline trust value. As one example, if the baseline trust value is on a scale of 1, and a particular element has a trust value of 6 out of a maximum of 10, then the element may have a normalized trust value of 0.6. However, teachings of certain embodiments recognize that trust values may be normalized in any suitable manner.

In the illustrated embodiment, weights repository 260 stores weights data 262. Weights data 262 identifies how each sub-element effects trust of an element and/or other sub-elements. For example, in the example system 100A of FIG. 1A, each element (e.g., sub-system, component, and part) may be assigned a weight value W(t). In this example, the sum of the weight values W(t) for each sub-element is equal to 1. In addition, the weights for each sub-element may be a function of the other sub-elements. For example, some elements may have a higher influence because they are more likely to cause propagation of trust or distrust. Returning to the computer network example, a network server may have a higher influence than a workstation because the network server interacts with more elements of the network.

In the illustrated embodiment, trust store 270 stores trust data 272. Trust data 272 may include an overall trust determined as a function of the trusts of one or more elements or sub-elements. For example, trust data 272 may include any trust values calculated from element trust data 252. Thus, in some embodiments, element trust data 252 represents received trust values, whereas trust data 272 may represent calculated trust values. In one example, element trust data 252 includes trust values for the lowest-level elements, here Tᵢⱼₖₗₘ, and trust engine 280 calculates values for Tᵢ, Tᵢⱼ, Tᵢⱼₖ, and Tᵢⱼₖₗ and stores them as part of trust data 272.

In the example system 100A of FIG. 1A, trust data 272 may include the total system trust of 100A determined from sub-system trust 1, sub-system trust 2, and sub-system trust n. In addition, trust data 272 may include the sub-system trust 1 determined from component trust 1, component trust 2, and component trust n, and so on.

In the illustrated embodiment, trust engine 280 receives elements data 242, element trust data 252, and weights data 262, and determines trust data 272. Trust engine 280 may determine trust data 272 in any suitable manner. In one embodiment, trust engine 280 may identify elements of a system from elements data 242, receive trust values for each of the identified elements from element trust data 252, and receive weight values from weights data 262 defining the influence of each of the identified elements. In this example, trust engine 280 may apply the received weight values to the received trust values to determine trust of a system. In one example, if (1) elements data 242 identifies elements A, B, and C as being a part of a system; (2) element trust data 252 identifies trust values T_{A}, T_{B}, and T_{c} corresponding to elements A, B, and C; and (3) weights data 262 identifies weights W_{A}, W_{B}, and W_{C} corresponding to elements A, B, and C; then trust engine 280 may determine overall system trust as being equal to the sum of the products of the identified trust values and weights:

T=T_{A}·W_{A}+T_{B}·W_{B}+T_{C}·W_{C}

However, teachings of certain embodiments recognize that trust engine 280 may determine trust data 272 in any suitable manner.

FIG. 2B shows computer system 210 according to one embodiment. Computer system 210 may include processors 212, input/output devices 214, communications links 216, and memory 218. In other embodiments, computer system 210 may include more, less, or other components. Computer system 210 may be operable to perform one or more operations of various embodiments. Although the embodiment shown provides one example of computer system 210 that may be used with other embodiments, such other embodiments may utilize computers other than computer system 210. Additionally, embodiments may also employ multiple computer systems 210 or other computers networked together in one or more public and/or private computer networks, such as one or more networks 230.

Processors 212 represent devices operable to execute logic contained within a medium. Examples of processor 212 include one or more microprocessors, one or more applications, and/or other logic. Computer system 210 may include one or multiple processors 212.

Input/output devices 214 may include any device or interface operable to enable communication between computer system 210 and external components, including communication with a user or another system. Example input/output devices 214 may include, but are not limited to, a mouse, keyboard, display, and printer.

Network interfaces 216 are operable to facilitate communication between computer system 210 and another element of a network, such as other computer systems 210. Network interfaces 216 may connect to any number and combination of wireline and/or wireless networks suitable for data transmission, including transmission of communications. Network interfaces 216 may, for example, communicate audio and/or video signals, messages, internet protocol packets, frame relay frames, asynchronous transfer mode cells, and/or other suitable data between network addresses. Network interfaces 216 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 218 represents any suitable storage mechanism and may store any data for use by computer system 210. Memory 218 may comprise one or more tangible, computer-readable, and/or computer-executable storage medium. Examples of memory 218 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 218 stores logic 220. Logic 220 facilitates operation of computer system 210. Logic 220 may include hardware, software, and/or other logic. Logic 220 may be encoded in one or more tangible, non-transitory media and may perform operations when executed by a computer. Logic 220 may include a computer program, software, computer executable instructions, and/or instructions capable of being executed by computer system 210. Example logic 220 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 220 may also be embedded within any other suitable medium without departing from the scope of the invention.

Various communications between computers 210 or components of computers 210 may occur across a network, such as network 230. Network 230 may represent any number and combination of wireline and/or wireless networks suitable for data transmission. Network 230 may, for example, communicate internet protocol packets, frame relay frames, asynchronous transfer mode cells, and/or other suitable data between network addresses. Network 230 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although trust management system 200 shows one network 230, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

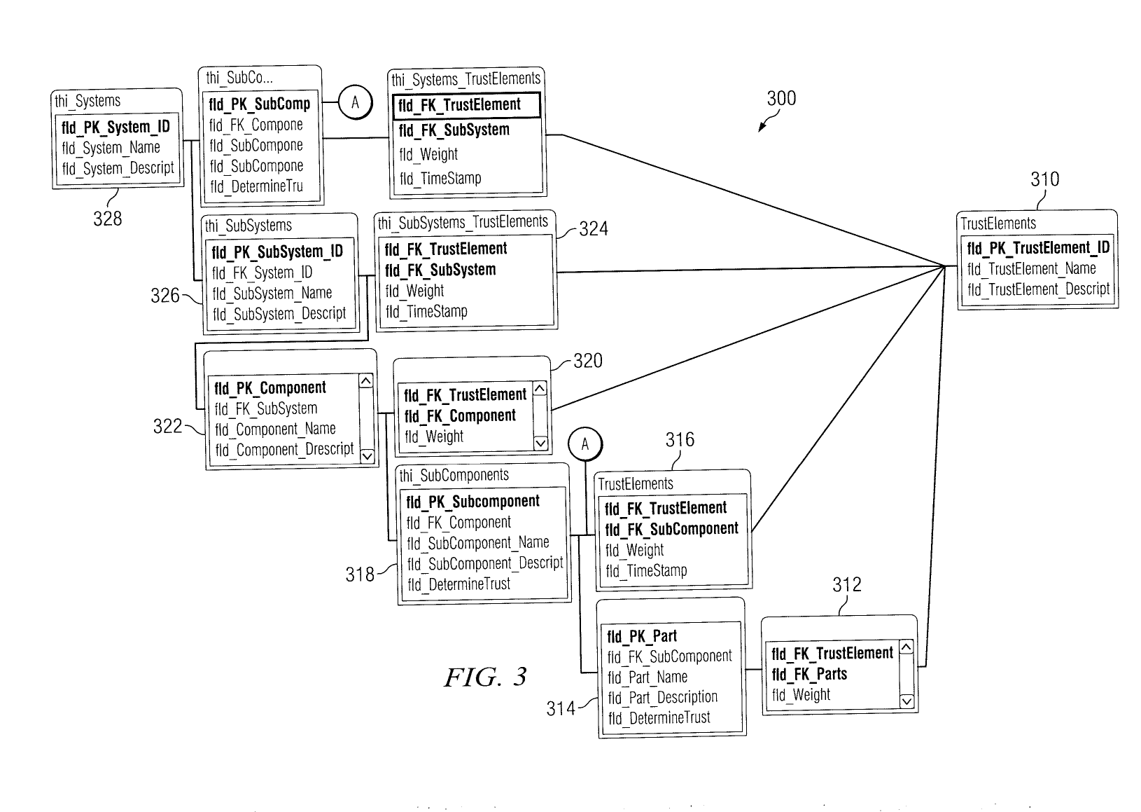

FIG. 3 shows an example entity relationship diagram (ERD) 300 according to one embodiment. ERD 300 shows example relationships between elements. More specifically, ERD 300 shows tasks to be performed in determining system trust, the relationship between the tasks, the impact of each element, and the variable nature of this impact.

In the example ERD 300, trust values for each element are identified by task 310. In this example, task 310 identifies elements such as subsystems, components, subcomponents, and parts. Task 312 identifies trust values for each part and weights for each part. Task 314 identifies weighted trust values for each part based on the trust values and the weights identified by task 312. Task 316 identifies trust values for each subcomponent and weights for each subcomponent. Task 318 identifies weighted trust values for each subcomponent based on the trust values and the weights identified by task 316. Task 320 identifies trust values for each component and weights for each component. Task 322 identifies weighted trust values for each component based on the trust values and the weights identified by task 320. Task 324 identifies trust values for each subsystem and weights for each subsystem. Task 326 identifies weighted trust values for each subsystem based on the trust values and the weights identified by task 324. Task 328 identifies total system trust based on the weighted trust values for each subsystem.

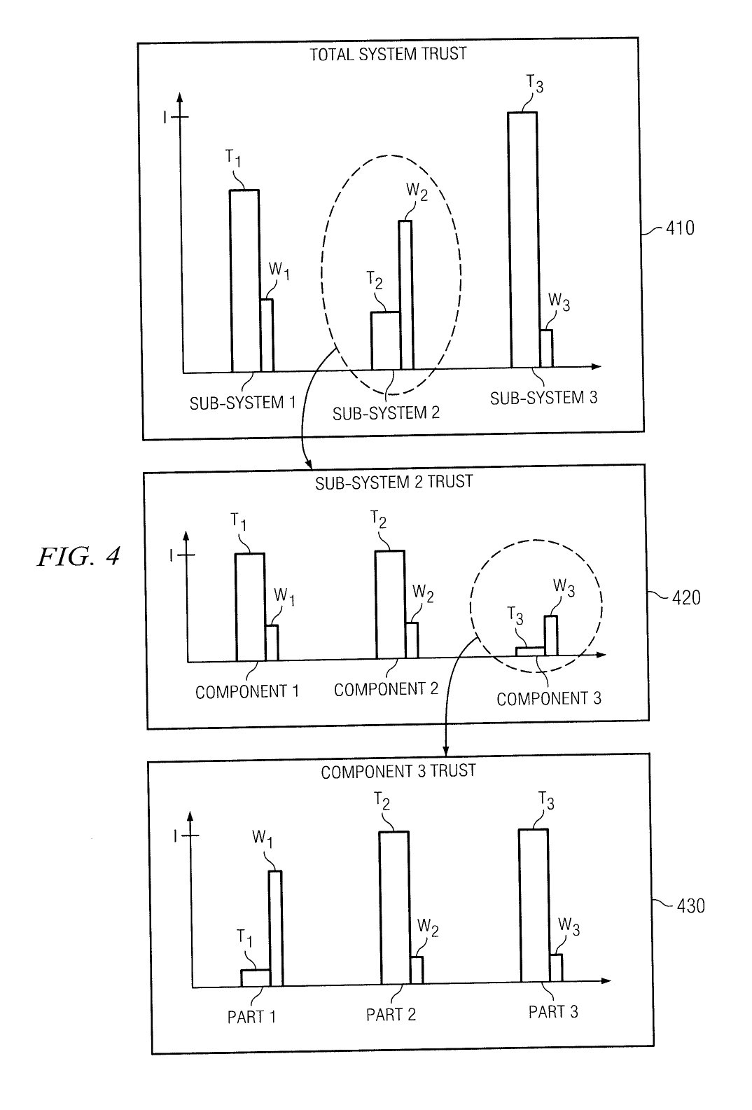

FIG. 4 shows an example trust visualization according to one embodiment. In this example, for each system or element, sub-element trust values and weights are shown in a bar graph. However, teachings of certain embodiments recognize that trust may be visualized in other suitable manners. For example, in some embodiments, a polar chart approach for tracking elements and their weights may simplify an operator's task of tracking trust by showing the elements with greater impact or influence (i.e., higher priority) closer to the center. In some embodiments, visualization may also include numeric values for trust and/or weight.

Teachings of certain embodiments recognize that visualization tools may enable an operator to identify vulnerabilities in a system and respond to correct those vulnerabilities. In the example of FIG. 4, bar graphs show the trust value and weight for each sub-element. In the illustrated example, a system includes sub-systems 1, 2, and 3. A graph 410 shows the trust values and weights of sub-systems 1, 2, and 3. In some embodiments, graph 410 may show the product of trust values and weights in place of or in addition to the trust values and weights.

As shown in graph 410, sub-system 1 and sub-system 3 have high trust values but relatively low weights. Sub-system 2, on the other hand, has a high weight but a low trust value. Based on this visualization, an operator may recognize that sub-system 2 is bringing down the overall system trust. This operator may wish to improve the trust of sub-system 2 by determining why sub-system 2 is currently vulnerable. Thus, teachings of certain embodiments recognize the ability to identify vulnerabilities by visualizing the trust values and weights of the components of sub-system 2.

In the illustrated example, sub-system 2 includes components 1, 2, and 3. A graph 420 shows the trust values and weights of components 1, 2, and 3. In some embodiments, graph 420 may show the product of trust values and weights in place of or in addition to the trust values and weights.

As shown in graph 420, components 1, 2, and 3 have the same weights, but component 3 has a substantially lower trust value. Based on this visualization, an operator may recognize that component 3 is bringing down the overall trust of sub-system 2. This operator may wish to improve the trust of component 3 by determining why component 3 is currently vulnerable. Thus, teachings of certain embodiments recognize the ability to identify vulnerabilities by visualizing the trust values and weights of the parts of component 3.

In the illustrated example, component 3 includes parts 1, 2, and 3. A graph 430 shows the trust values and weights of parts 1, 2, and 3. In some embodiments, graph 430 may show the product of trust values and weights in place of or in addition to the trust values and weights.

As shown in graph 430, parts 2 and 3 have high trust values and low weights. However, part 1 has a high weight and a low trust value. Based on this visualization, an operator may recognize that part 1 is bringing down the overall trust of component 3. If part 1 does not include any sub-parts to be analyzed, the operator may determine that part 1 should be repaired or replaced. In this example, replacing part 1 may improve the overall system trust by improving component 3 trust, which improves sub-system 1 trust, which improves the overall system trust.

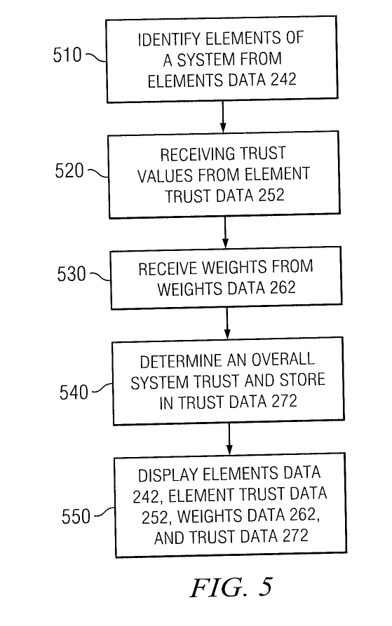

FIG. 5 shows a method 500 of determining system trust according to one embodiment. At step 510, elements of a system are identified from elements data 242. At step 520, trust values for the identified elements are received from element trust data 252. At step 530, weights for the identified elements are received from weights data 262. At step 540, an overall system trust is determined as a function of the received elements data 242, element trust data 252, and weights data 262. The overall system trust is stored in trust data 272.

At step 550, elements data 242, element trust data 252, weights data 262, and trust data 272 is displayed. In one example, this data is displayed in an visualization, such as the visualization of FIG. 4. For example, the sub-systems, components, and parts of FIG. 4 may be identified from elements data 242. The weight values for the sub-systems, components, and parts of FIG. 4 may be received from weights data 262. The trust values for the parts of FIG. 4 may be received from element trust data 252. The trust values for the components calculated from the weights and trust values for the parts may be sorted in trust data 272. Similarly, the trust values for the sub-systems calculated from the weights and the trust values for the components may be stored trust data 272, as well as the overall trust value calculated from the weights and the trust values for the sub-systems.

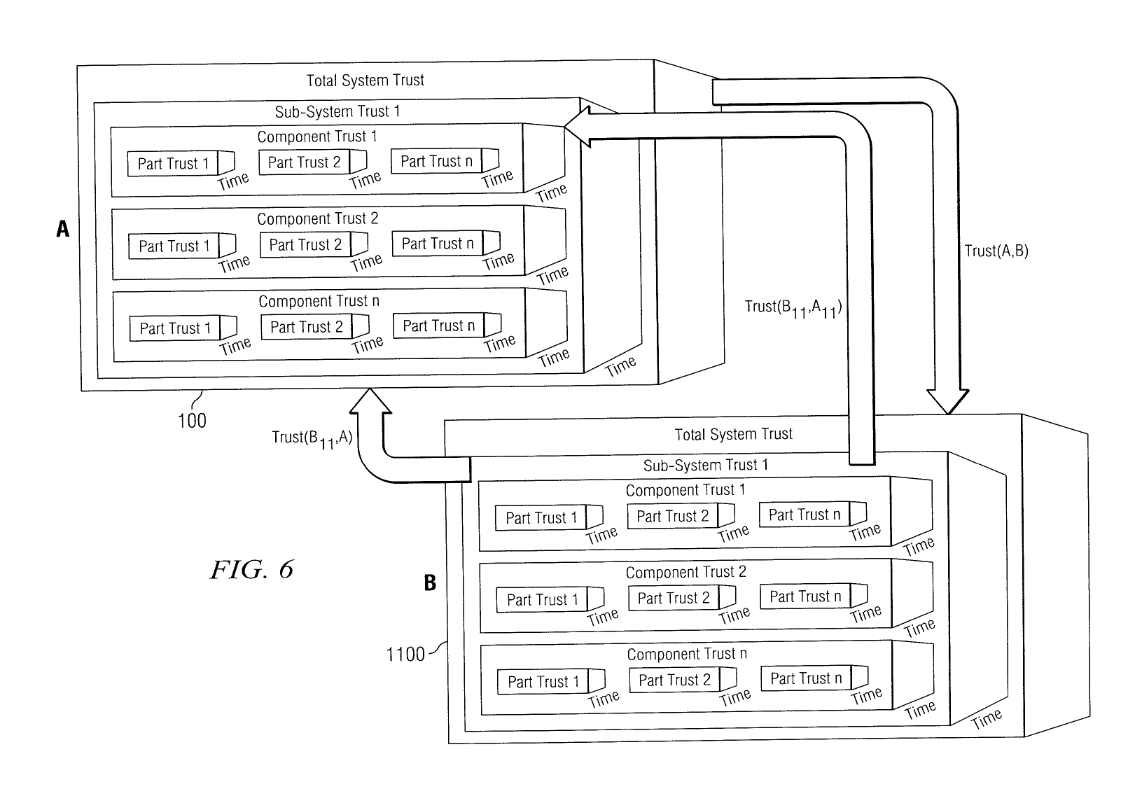

FIG. 6 shows two example systems and the inter-trust level between them. In this example, system 100 of FIG. 1 interacts with system 1100. As shown in FIG. 6, interaction between systems may be possible at all levels, such as between a part of a first system and a component of a second system. Accordingly, teachings of certain embodiments recognize the capability to track and measure trust between elements contained in different levels and/or in different systems to accurately represent a total trust, T. For example, Trust(A,B) represents the trust between system 100 and 1100. Trust(B₁₁,A₁₁) represents the trust between sub-system 1 of system 100 and sub-system 1 of system 1100. Trust(B₁₁,A) represents the trust between system 100 and sub-system 1 of system 1100.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

What is claimed is:

1. A computer for determining an overall level of trust of a system, comprising:
a memory operable to store:
a level of trust for each of a plurality of elements of the system; and
a weight for each of the plurality of elements, each weight indicating an influence of each of the plurality of elements on the trust of the system; and
a processor configured to:
determine for each element a contribution to the overall level of trust of the system based on the level of trust for each element and the weight for each element; and
determine the overall level of trust of the system based on the determined contribution for each element.

2. The computer of claim 1, wherein at least one of the stored levels of trust change as a function of time.

3. The computer of claim 1, wherein at least one of the stored weights change as a function of time.

4. The computer of claim 1, the processor further configured to display the overall level of trust and at least one of the determined contributions.

5. The computer of claim 1, the processor further configured to display at least one of the received levels of trust and at least one of the received weights.

6. The computer of claim 1, wherein the processor is configured to:
determine for each element a contribution to the overall level of trust of the system by multiplying, for each element, the level of trust for that element by the weight of that element to yield the contribution of that element to the overall level of trust of the system; and
determine the overall level of trust of the system by adding the determined contributions for each element.

7. Logic encoded on a non-transitory computer-readable medium such that, when executed by a processor, is configured to:
receive a level of trust for each of a plurality of elements of the system;
receive a weight for each of the plurality of elements, each weight indicating an influence of each of the plurality of elements on the trust of the system;
determine for each element a contribution to the overall level of trust of the system based on the level of trust for each element and the weight for each element; and
determine the overall level of trust of the system based on the determined contribution for each element.

8. The logic of claim 7, wherein at least one of the received levels of trust change as a function of time.

9. The logic of claim 7, wherein at least one of the received weights change as a function of time.

10. The logic of claim 7, the logic when executed being further configured to display the overall level of trust and at least one of the determined contributions.

11. The logic of claim 7, the logic when executed being further configured to display at least one of the received levels of trust and at least one of the received weights.

12. The logic of claim 7, the logic when executed being further configured to determine, for one element of the plurality of elements, the level of trust for the one element by:
identifying a plurality of sub-elements of the one element;
receiving a level of trust for each of a plurality of sub-elements;
receiving a weight for each of the plurality of sub-elements, each weight indicating an influence of each of the plurality of sub-elements on the level of trust for the one element;
determining for each sub-elements a contribution to the level of trust for the one element based on the level of trust for each sub-element and the weight for each sub-element; and
determining the level of trust for the one element based on the determined contribution for each sub-element.

13. The logic of claim 7, the logic when executed being further configured to:
determine for each element a contribution to the overall level of trust of the system by multiplying, for each element, the level of trust for that element by the weight of that element to yield the contribution of that element to the overall level of trust of the system; and
determine the overall level of trust of the system by adding the determined contributions for each element.

14. A method of determining an overall level of trust of a system, comprising:
receiving a level of trust for each of a plurality of elements of the system;
receiving a weight for each of the plurality of elements, each weight indicating an influence of each of the plurality of elements on the trust of the system;
determining for each element a contribution to the overall level of trust of the system based on the level of trust for each element and the weight for each element; and
determining the overall level of trust of the system based on the determined contribution for each element.

15. The method of claim 14, wherein at least one of the received levels of trust change as a function of time.

16. The method of claim 14, wherein at least one of the received weights change as a function of time.

17. The method of claim 14, further comprising displaying the overall level of trust and at least one of the determined contributions.

18. The method of claim 14, further comprising displaying at least one of the received levels of trust and at least one of the received weights.

19. The method of claim 14, further comprising determining, for one element of the plurality of elements, the level of trust for the one element by:
identifying a plurality of sub-elements of the one element;
receiving a level of trust for each of a plurality of sub-elements;
receiving a weight for each of the plurality of sub-elements, each weight indicating an influence of each of the plurality of sub-elements on the level of trust for the one element;
determining for each sub-elements a contribution to the level of trust for the one element based on the level of trust for each sub-element and the weight for each sub-element; and
determining the level of trust for the one element based on the determined contribution for each sub-element.

20. The method of claim 14, wherein:
determining for each element a contribution to the overall level of trust of the system comprises multiplying, for each element, the level of trust for that element by the weight of that element to yield the contribution of that element to the overall level of trust of the system; and
determining the overall level of trust of the system comprises adding the determined contributions for each element.
